(19) United States
(12) Patent Application Publication
(10) Pub. No.: US 2008/0016732 A1
(43) Pub. Date: Jan. 24, 2008

(54) Structure For The Creation Of Greeting Cards, Books, Containers, Lampshades And Decorative Screens

(76) Inventor: Chanan Gardi, Impruneta (IT)

Correspondence Address: THE WEBB LAW FIRM, P.C., 700 KOPPERS BUILDING, 436 SEVENTH AVENUE, PITTSBURGH, PA, 15219, US

(21) Appl. No.: 11/667,613

(22) PCT Filed: Nov. 10, 2005
(86) PCT No.: PCT/IT05/00654

§ 371 Date: May 11, 2007

(30) Foreign Application Priority Data
Nov. 12, 2004 (IT) FI2004A000236

(51) Int. Cl. G09F 1/00

(52) U.S. Cl. 40/124.08

(57) ABSTRACT

A structure for creating greeting cards, books, containers, lampshades or decorative screens, utilizing a structure which has a central hinge axis and two collapsible half face and is formed from two elements associated with each other so as to define an anterior face and a posterior face which, with structure folded, create an inner or internal and an outer or external surface; one of said elements providing an opening through which a piece of fabric protrudes; said fabric being disposed between the two elements; the structure characterized in that said element provides a connecting piece, said piece of fabric being fixed to said connecting piece and integral with the latter.

The present invention provides a structure which can be used to create greeting cards, books, containers, lampshades, and decorative screens. Obviously, the dimensions of the structure will depend on the function of the object which is created.

This structure can be used in several forms. In the simplest form (heretofore called structure 1), the structure of the present invention contains a hinge axis between two half faces on its left and right sides. Each half face is, in turn, composed of two flat elements which are coupled to each other and which create an anterior and posterior side of each half face. When the structure is folded along the hinge axis, an inner (internal) surface and an outer (external) surface are created in the structure. In the present description, the inner surface will be referred to as element 2 and the outer surface will be referred to as element 3. The internal element has an opening and between internal element 2 and external element 3, a portion of fabric (preferably elastic) is placed so that the fabric can partially protrude from the face of element 2.

The document EP-1449678 describes a structure which is also formed by two elements coupled to each other which have, between them a portion of elastic fabric. This fabric can protrude through an opening in one or in both elements. The fabric, which is preferably left loose, is only manually modifiable. In this document, this structure is said to be useful, although not exclusively, in stationery, in publishing, as well as in envelopes or packages. The user can also change the appearance of this structure to use it for games or amusements.

The present invention has as its aim to provide a structure which will modify both substantially and automatically the fabric in the opening in element 2. Specifically, this is done by the opening of the structure which makes the inner face visible. In the structure of the present invention, the elastic fabric is extracted, that is, raised from the surface of the coupled elements, in an automatic way and as a direct result of the opening of the structure. Any structure based on and in conformity with the present invention is, moreover, relatively simple and economical to make, and its characteristics remain unchanged after extended use. This result has been reached by adopting the concept to realize a structure having the characteristics of claim 1. Other characteristics of the invention are described in the dependent claims.

In the description that follows, reference will be made to the attached drawings which are considered to be non-limiting examples, wherein:

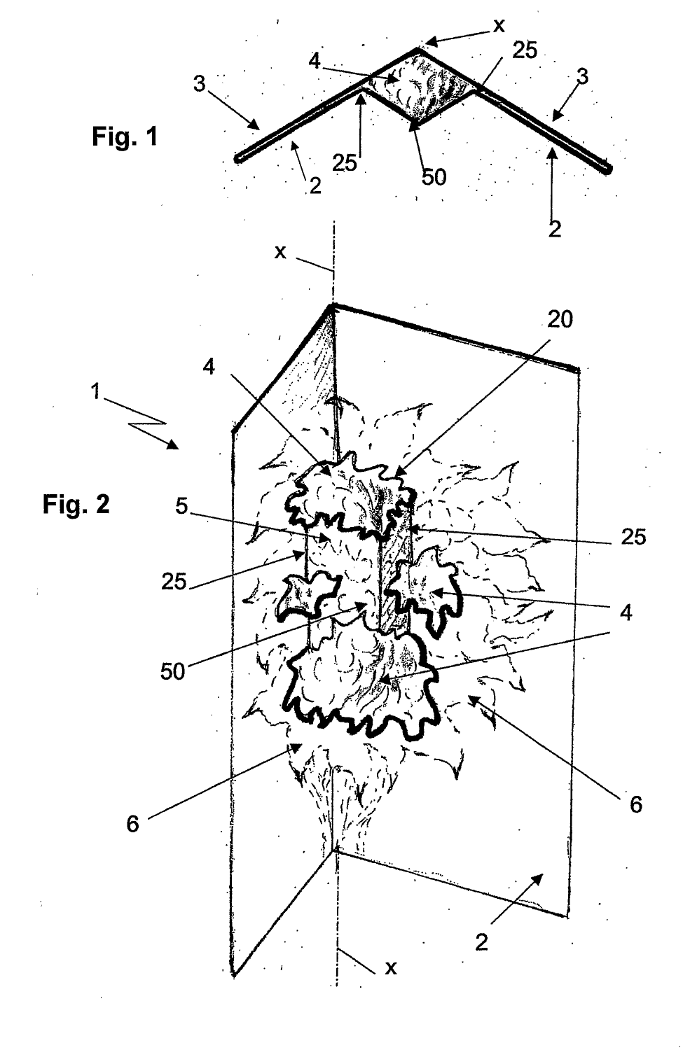

FIG. 1 is a schematic top view of a possible embodiment of a structure according to the invention, in the shape of a postcard or a greeting card;

FIG. 2 shows the embodiment of FIG. 1, in a schematic perspective (3-dimensional) view;

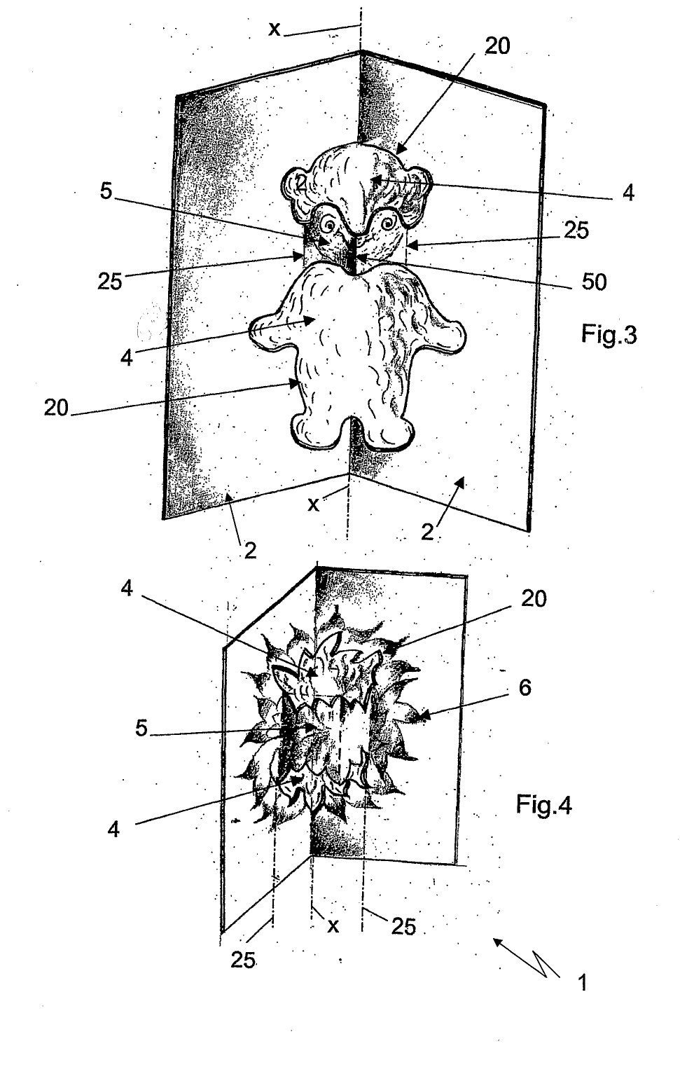

FIG. 3 is a schematic perspective (3-dimensional) view of another possible embodiment of the invention in which the structure defines a card;

FIG. 4 is a schematic perspective (3-dimensional) view of a further embodiment of the invention in which the structure is a card;

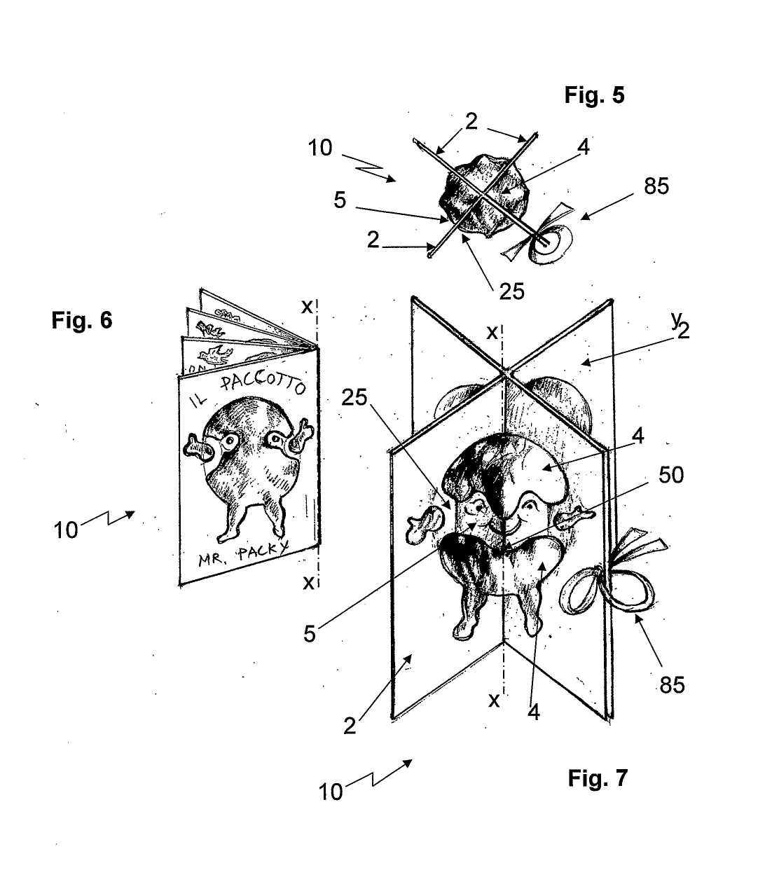

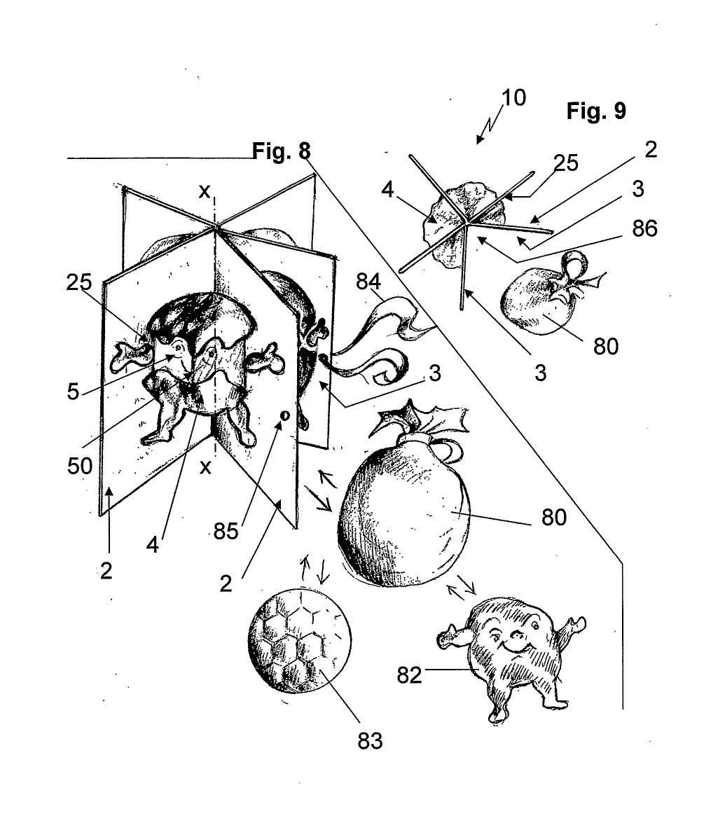

FIGS. 5, 6, 7, 8, 9 show an embodiment of the invention in which the structure is a container with several functions; in particular, FIG. 5 is a top view of the example in closed configuration; FIG. 6 is a perspective (3-dimensional) view of the folded structure; FIG. 7 is a perspective (3-dimensional) view of the structure in conformation of FIG. 5; FIG. 8 is a perspective view of the open container, with possible examples of objects contained in the same; FIG. 9 is a schematic top view of the example of FIG. 8;

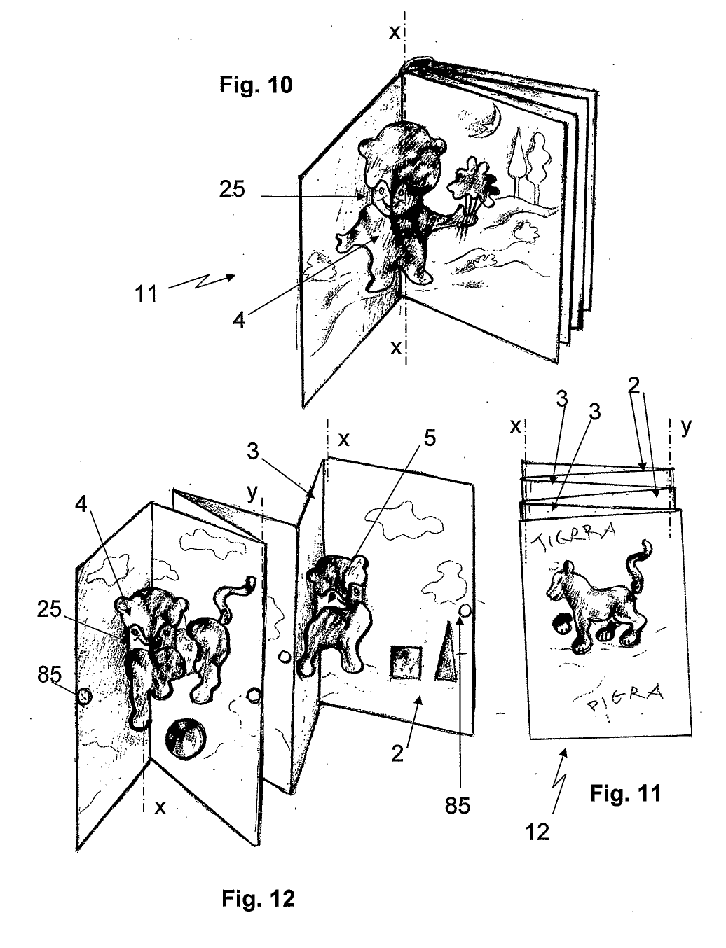

FIG. 10 is a perspective (3-dimensional) view of a structure which forms a book;

FIGS. 11, 12 show a further embodiment of the invention in which the structure can be a ludic element or game for children or, in greater dimensions, a decorative screen, and

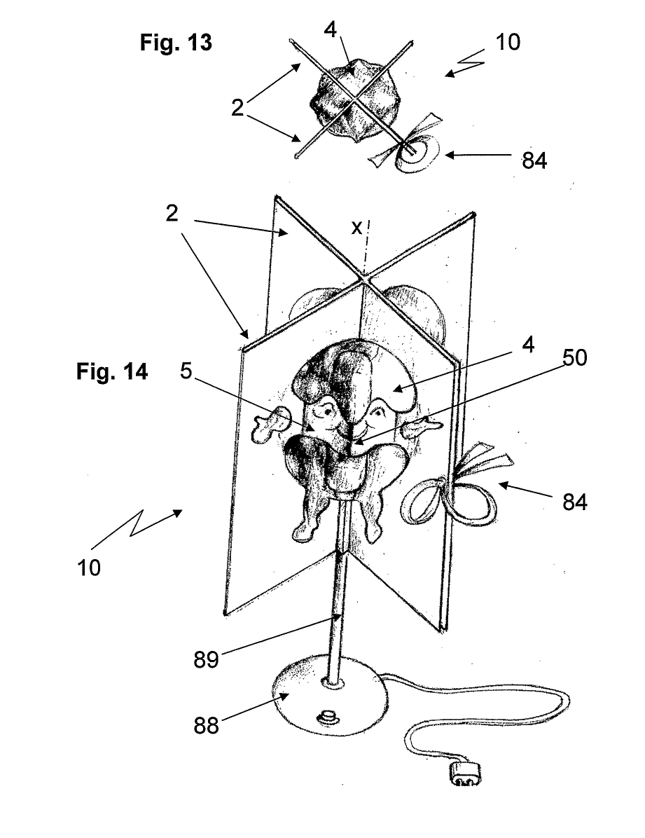

FIGS. 13, 14 show an embodiment of the invention in which the structure is a lampshade; in particular, FIG. 13 is a top view of the example and FIG. 14 is a perspective (3-dimensional) view of the structure.

In the figures of the attached drawings, the basic or simplest structure (structure 1) is marked with a “1”.

As previously stated, structure 1 is a type of collapsible structure with a hinge axis x-x between two half faces on its right and left sides. Each half face is, in turn, made up of two associated parts (elements 2 and 3) which are coupled to each other so as to create an anterior and posterior face. The structure will be defined as being open when the inner face (defined by the element 2) is visible. It will be defined as closed when the said inner face is not visible. Element 2 is provided with an opening 20 as shown, for example, in FIGS. 2 through 4. Across the opening is a central connecting piece 5 which divides the one opening into at least two smaller openings. This central piece can be a separate piece attached to element 2 on each half face, or it can be cut out from element 2. This opening 20 has been divided into two portions by the central connecting piece 5, one opening above the central piece and the other below it. In addition, a variation of this structure 1 would have element 3 having one or more openings (not shown in the examples) coinciding with those one or more openings in element 2. In this case, the altered structure 1 will be characterized by light diffusion through the central fabric.

Between element 2 and element 3 is a portion of elastic fabric 4 so that the fabric can partially protrude from the face of element 2 through an opening 20.

In addition, besides fabric or cloth, the material used in portion 4 can be also in other materials like, as an example, flexible not woven material, or flexible plastic materials. In the present invention, the element 2 has a connecting piece 5 that joins the two element 2 faces on opposite sides of the hinge axis x-x- and on opposite sides of the opening 20. This connecting piece 5 has a bending line 50 which defines a second hinge that is opposite to the first hinge defined by the axis x-x. This second hinge is a mirror-image albeit smaller of the first hinge when structure 1 is in an open configuration. Where the connecting piece 5 is fixed to element 2, hinges 25 are created, one each on the two faces of element 2. The piece 5 can be realized in a single body with element 2, that is cut out from element 2, by die cutting or by laser cutting when the element 2 is a cardboard or paper material. It can be easily cut to form the desired shape of opening 20 and, consequently, of piece 5. As well, alternatively, the connecting piece 5 can have its own independent shape by adding a strip or piece of material to element 2 while structure 1 is being assembled. The fabric 4 is fixed to connecting piece 5 so as to become an integral part of piece 5. In an open configuration, both fabric 4 and piece 5 are thus raised together above element 2 of structure 1. When structure 1 is opened, the two half faces rotate around the axis x-x, while piece 5 is raised above element 2. The angle at hinge 50 is always the same angle as the bending angle of structure 1 at hinge axis x-x. As an example, in the configuration represented in FIG. 3, the angle formed from structure 1 is a right angle and the angle formed at the hinge 50 of piece 5 is also a right angle. In the present invention, right angle configuration of the structure 1 provides a totally new effect in greeting cards.

When structure 1 is closed, hinge 50 moves away from the hinge axis x-x, flattening piece 5, until reaching a minimum or zero degree angle configuration, where the shape of the structure is substantially planar.

A drawing or design 6 can be made on the surface of element 2. This design 6 can be made to be an integral part of the design of one or more openings 20 to create a total unified card design. For example, in FIG. 4, the front face (element 2) of structure 1 is a design 6 visible where said total design is composed of design 6, of the piece 5, of opening 20 and of fabric 4 that protrudes upward from element 2. In FIGS. 1-4 the invention is shown in a postcard or greeting card shape.

Two or more structure 1 shapes of the present invention can assembled to create other structural embodiment of structure: for example, in FIGS. 5-9, the structure embodiment forms a container 10, suitable for small objects, gifts, fragrances, candies, etc. In this case, the embodiment 10 is formed by a plurality of elements 2 and 3 associated with each other, so as to form a succession of faces. When the last element of the succession is joined to the first one, a central storage container is formed by the fabric 4 and by the connecting pieces 5 of all the faces as they coincide to form an inner storage area 86. The storage area 86 is usable for objects of small dimensions (in FIGS. 5-9 are shown a ball 83 and a puppet 82, which can be inserted in storage container bag 80). The structure 10 so formed can be maintained closed by a lace 84 passing through corresponding holes 85. The storage container 10 of the FIGS. 5-9 can be used also as a lampshade, for example, in FIGS. 14, 15 a light bulb is inserted in the inner vain 86 converting into a light diffuser and creating a lamp and/or a light-book. In these figures, numeral 88 denotes a base for the light diffuser and 89 the relevant supporting stem.

In FIG. 10, the structure 1 embodiment forms also a book 11, where one or more inner pages have the characteristics of the invention; that is, they have a piece 5 that pulls a fabric 4 away from the page surface.

In the examples of FIGS. 11 and 12, structural embodiment of the structure 1 is formed by a plurality of elements 2 and 3 associated each other in succession, that is, they are joined along the vertical hinges or axes of x and y. Here, axes x indicate the axes around which rotate the two half faces which open the structure, while the axes y indicate the connection hinges between more structures 1. This structural embodiment 12 forms a ludic element for children or a decorative screen in small dimensions, or a decorative screen in larger dimensions.

Elements 2 and 3 can be made of different material like, such as cardboard, paper, plastic, metal, wood, leather, etc.. Between the fabric 4 and the element 3 can be disposed a layer of plastic material (i.e. PVC) for a better industrial assembly.

When cardboard, paper or a flexible plastic material is used, the lines of bending 25 are formed by these materials; however, when materials that not are easily foldable are used, the structure can include hinges at the lines of the bending 25. Clearly, changes may be made to the forms, dimensions, component parts as well as to the locations of folding and type of materials employed in all embodiments described and illustrated herein without, however, departing from the scope of the present invention.

1-10. (canceled)

11: A structure for creating greeting cards, books, containers, lampshades or decorative screens, comprising:
two elements associated with and superimposed on each other so as to define an anterior face and a posterior face; said structure foldable along a central hinge axis which divides the front face of the structure in two semi-faces; and
a piece of fabric disposed between the two elements and protruding through an opening of a first of said two elements;
wherein said first element includes a connecting piece connecting the two semi-faces of the first element, and wherein said piece of fabric is fixed to said connecting piece and is integral therewith.

12: The structure of claim 11, wherein said connecting piece has a folding line which defines a second hinge substantially parallel to the central hinge axis, wherein the second hinge is adapted to open said connecting piece in a mirrored relation to the structure being opened along the central hinge axis.

13: The structure of claim 11, wherein said fabric is loosely arranged in the opening of the two elements.

14: The structure of claim 11, wherein said fabric is elastic.

15: The structure of claim 11, wherein said first element and said connecting piece are formed by a single body.

16: The structure of claim 11, wherein said connecting piece is a strip or piece of material applied to said first element.

17: The structure of claim 11, wherein said opening of said first element is symmetrically arranged in relation to the central hinge axis.

18: The structure of claim 11, wherein the second element of said two elements includes at least one opening.

19: A structural embodiment comprised of a succession of a plurality of substructures, wherein each substructure comprises:
two elements associated with and superimposed on each other so as to define an anterior face and a posterior face; said structure foldable along a central hinge axis which divides the front face of the structure in two semi-faces; and
a piece of fabric disposed between the two elements and protruding through an opening of a first of said two elements; wherein said first element includes a connecting piece connecting the two semi-faces of the first element, and wherein said piece of fabric is fixed to said connecting piece and is integral therewith, wherein adjacent substructures are joined to each other along respective edges thereof.

20: A structural embodiment comprised of a succession of a plurality of substructures, wherein each substructure comprises:
two elements associated with and superimposed on each other so as to define an anterior face and a posterior face; said structure foldable along a central hinge axis which divides the front face of the structure in two semi-faces; and
a piece of fabric disposed between the two elements and protruding through an opening of a first of said two elements;
wherein said first element includes a connecting piece connecting the two semi-faces of the first element, and wherein said piece of fabric is fixed to said connecting piece and is integral therewith, wherein the connecting pieces of each element of each substructure form a storage area when a last element in the succession of the plurality of substructures is adjacent to a first element in the succession of the plurality of substructures.

21: The structural embodiment of claim 19, wherein said connecting piece has a folding line which defines a second hinge substantially parallel to the central hinge axis, wherein the second hinge is adapted to open said connecting piece in a mirrored relation to the substructure being opened along the central hinge axis.

22: The structural embodiment of claim 20, wherein said connecting piece has a folding line which defines a second hinge substantially parallel to the central hinge axis, wherein the second hinge is adapted to open said connecting piece in a mirrored relation to the substructure being opened along the central hinge axis.
